(19) United States
(12) Patent Application Publication
(10) Pub. No.: US 2018/0241738 A1
(43) Pub. Date: Aug. 23, 2018

(54) USING A PROXY SERVER TO INTERCEPT AND ANALYZE CONTENT

(71) Applicant: OBSERVEPOINT, INC., Provo, UT (US)

(72) Inventors: Robert K. Seolas, Alpine, UT (US); John Pestana, Orem, UT (US); John Pestana, Provo, UT (US); Alan Martin Feuerlein, Orem, UT (US)

(21) Appl. No.: 14/907,530

(22) PCT Filed: Nov. 9, 2015
(86) PCT No.: PCT/US15/59753

§ 371 Date: Jan. 25, 2016

(51) Int. Cl. H04L 29/06; H04L 29/08; H04L 9/32

(52) U.S. Cl. CPC H04L 63/0823; H04L 63/0281; H04W 12/04; H04L 9/3263; H04L 67/22

(57) ABSTRACT

A method for auditing tags launched within a target mobile application comprises analyzing a network communication generated by a target mobile application to determine if an identifiable tag signature is present within the network communication. An identifiable tag signature can comprise one or more attributes that are associated with the firing of a tag. Based upon a detected tag signature, the method can further comprise determining that a particular tag fired. Further the method can comprise recording information associated with the particular tag. Methods are also provided for inspecting encrypted data traffic and generating reports thereon. Encrypted network communications are intercepted, decrypted using a digital certificate, digital signatures are identified, and reports are generated indicating which digital signatures were found to match tag signatures.

### CROSS-REFERENCE TO RELATED APPLICATIONS

The present invention is a 35 U.S.C. § 371 U.S. National Stage of PCT PCT/US15/59753, filed Nov. 9, 2015, the entire content of which is incorporated herein by reference.

### BACKGROUND OF THE INVENTION

### 1. The Field of the Invention

The present invention relates to systems, methods, and computer program products related to analysis of mobile applications.

### 2. Background and Relevant Art

Mobile devices, such a tablet computers and smart phones, have experienced explosive growth and market penetration in recent years. Accompanying this growth, the mobile application market has also experienced tremendous growth. Mobile applications can range from simple games to complex productivity software. In many cases, regardless of the type of mobile application, the mobile application communicates through the Internet to various servers. The servers can be used to store user created content, provide additional features, allow a developer to track software and user behavior, or provide other similar services.

As an exemplary mobile application, a newspaper may create a dedicated mobile application for accessing content on its webpage. For example, a newspaper may create a mobile application that acts as a web portal to its standard webpage. Using the mobile application, a user can easily navigate the newspaper's content. In some conventional systems, the mobile application may provide a user experience that is very similar to the user experience provided through a general purpose mobile web browser.

Similar to webpages that are accessed through conventional computer-based web browsers, the content viewable by the mobile application may comprise various pieces of code, sometimes referred to as “tags,” that are configured to execute (i.e., “fire”) when the content is viewed. In at least one conventional form, a tag is a hidden element within a webpage that causes some action to occur on a webpage when it is fired. In particular, in at least one implementation, a tag is a piece of code that a webpage owner can place within a webpage, and allows the webpage owner to track information about the visitors who download and execute the particular piece of code or content.

For example, a tag can comprise a transparent GIF or a tracking pixel, which is placed within the code of a webpage. The actual transparent GIF or tracking pixel can be stored on a separate server from the actual webpage. The tag is fired when the browser requests the transparent GIF or tracking pixel from the separate server. When the separate server receives the request from the browser, the server can gather various analytic data about the requestor.

Once executed, a tag can gather information such as where the visitor came from (e.g., what webpage or search engine), what keywords were used to find the webpage, whether a particular advertisement directed a visitor to the page, and other related data. In many situations, a webpage can comprise multiple tags from a variety of different parties. For example, a particular webpage may contain a Google Analytics tag, a Facebook tag, a page-counter Tag, a weather tag, and other common tags. In at least one implementation, a tag can merely comprise a particular call to an external advertising server.

As mobile applications have become more pervasive and as more user have begun to access web-based content through custom mobile applications, content providers have also become more interested in ensuring that the various tags embedded within their web content are operating correctly within the mobile applications. In many cases, large amounts of advertising money are dependent upon tags correctly tracking visitors to a website.

Auditing mobile applications, however, presents several unique challenges. For example, due to the tremendous variety of mobile applications it is much more difficult to create a “standard” test environment. Additionally, many organizations create a mobile version of their web content, such that audits of their conventional web-based content do not necessarily correlate to audits of their mobile content. Furthermore, some applications have begun to encrypt some or all of the information they transmit to other servers. As such, it can be difficult to determine which of the encrypted traffic is a result of a tag firing and which is related to the transmission of other data.

Accordingly, there are a number of problems in the art relating to auditing web-based content that is accessed through mobile applications, and further relating to accessing encrypted content that is transmitted as a result of a fired tag.

### BRIEF SUMMARY OF THE INVENTION

Implementations of the present invention provide systems, methods, and computer program products configured to audit tags within mobile applications. In at least one implementation, a network communication from a particular mobile application is directed through an audit server. The audit server can then determine what tags are fired within the particular mobile application. Additionally, in at least one implementation of the auditing system, the mobile application can be executed within an application interface layer on a desktop computer. The application interface layer can comprise an emulator, a simulator, or a similar layer. The application interface layer can detect the tags that are fired within the mobile application. After auditing a mobile application, the auditing system can generate a report to a user of interest.

For example, at least one implementation of the present invention comprises a method of the mobile auditing application auditing tags launched within a target mobile application. The method includes intercepting, with the mobile auditing application, a network communication. The network communication can originate from the target mobile application. Additionally, the mobile auditing application and the target mobile application can both be installed on the mobile device. The method can further comprise analyzing the network communication to determine if an identifiable tag signature is present within the network communication. An identifiable tag signature can comprise one or more attributes that are associated with the firing of a tag. Based upon a detected tag signature, the method can further comprise determining that a particular tag fired. Further the method can comprise recording information associated with the particular tag.

At least one implementation of the present invention comprises an additional method of the mobile auditing application auditing tags launched within a target mobile application. The method includes directing, through a proxy server, a network communication, wherein the network communication originates from a target mobile application installed on a mobile device. The method can further comprise analyzing the network communication to determine if an identifiable tag signature is present within the network communication. An identifiable tag signature can comprise one or more attributes that are associated with the firing of a tag. Based upon a detected tag signature, the method can further comprise determining that a particular tag fired. Further the method can comprise recording information associated with the particular tag.

Additionally, at least another implementation of the present invention comprises a method of the mobile auditing application auditing tags launched within a target mobile application. The method includes intercepting, with the application interface layer, a network communication. The network communication can originate from the target mobile application. The application interface layer may be installed on a desktop computer or server. The target mobile application may be installed within the application interface layer. Additionally, the target mobile application may behave as if it is installed on a mobile device.

The method can further comprise analyzing the network communication to determine if an identifiable tag signature is present within the network communication. An identifiable tag signature can comprise one or more attributes that are associated with the firing of a tag. Based upon a detected tag signature, the method can further comprise determining that a particular tag fired. Further the method can comprise recording information associated with the particular tag.

At least one implementation of the present invention comprises a method for inspecting encrypted data traffic and generating reports thereon. The method includes intercepting an encrypted network communication that originates from the target device, where the encrypted network communication is addressed to a destination other than the proxy server. The method also includes decrypting the intercepted network communication using a digital certificate for which the proxy server is a certificate authority and identifying digital signatures within the decrypted network communication that match at least one digital signature from a pre-defined list of tag signatures, where each tag signature comprises attributes that are associated with the firing of a tag. The method further includes generating a report indicating which digital signatures of the decrypted network communication were found to match the tag signatures. The generated report also indicates which tag attributes are associated with the tag signatures.

At least one implementation of the present invention comprises a method for an auditing system auditing tags launched within a mobile application. The method includes intercepting an encrypted network communication that originates from the target device, where the encrypted network communication is addressed to a destination other than the proxy server. The method further includes decrypting the intercepted network communication using a digital certificate for which the proxy server is a certificate authority, and identifying digital signatures within the decrypted network communication that match at least one digital signature from a pre-defined list of tag signatures, where each tag signature includes attributes that are associated with the firing of a tag.

The method next includes generating a report indicating which digital signatures of the decrypted network communication were found to match the tag signatures, where the generated report further indicates which tag attributes are associated with the tag signatures. The method analyzes the network communication to determine if an identifiable tag signature is present within the network communication, where an identifiable tag signature includes attributes that are associated with the firing of a tag. Based upon a detected tag signature, the method then determines that a particular tag fired and records information associated with that tag.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an overview schematic diagram of a system for use in accordance with one or more implementations of the present invention;

FIG. 2 illustrates an overview schematic diagram of another system for use in accordance with one or more implementations of the present invention;

FIG. 3 illustrates an exemplary user interface for reporting an audit in accordance with an implementation of the present invention;

FIG. 4 illustrates a flowchart of a method in accordance with an implementation of the present invention of auditing mobile applications;

FIG. 5 illustrates a flowchart of another method in accordance with an implementation of the present invention of auditing mobile applications;

FIG. 6 illustrates a flowchart of yet another method in accordance with an implementation of the present invention of auditing mobile applications;

FIG. 7 illustrates an overview schematic diagram of a computing environment for use in accordance with one or more implementations of the present invention;

FIG. 8 illustrates an embodiment of a report that illustrates matches between digital signatures and tag signatures;

FIG. 9 illustrates an embodiment of a network communication that has a URL;

FIG. 10 illustrates a flowchart of another method in accordance with an implementation of the present invention of auditing mobile applications; and

FIG. 11 illustrates a flowchart of yet another method in accordance with an implementation of the present invention of auditing mobile applications.

### DETAILED DESCRIPTION OF THE PREFERRED EMBODIMENTS

Implementations of the present invention extend to systems, methods, and computer program products configured to audit tags within mobile applications. In at least one implementation, a network communication from a particular mobile application is directed through an audit server. The audit server can then determine what tags are fired within the particular mobile application. Additionally, in at least one implementation of the auditing system, the mobile application can be executed within an application interface layer on a desktop computer. The application interface layer can comprise an emulator, a simulator, or a similar layer. The application interface layer can detect the tags that are fired within the mobile application. After auditing a mobile application, the auditing system can generate a report to a user of interest.

Accordingly, implementations of the present invention provide improvements within the technical field of mobile computer software auditing. For example, implementations of the present invention can provide a mobile software developer with a previously unavailable system for auditing mobile software applications for proper tag firing. Additionally, various implementations of the present invention provide flexible systems for auditing a mobile software application as the software is executed on the mobile platform or within a desktop computer-based emulator or simulator.

One of skill in the art will appreciate the benefit that implementations of the current invention provide. In particular, in a digital world increasingly interconnected, the ability to verify that tags are properly firing can have significant impacts on revenue and product development. For example, a significant amount of web content is supported by advertising-related payments. In order to properly track the number of visitors, and the associated advertising costs, tags must be properly configured to fire. If content is being provided through dedicated applications, and the tags are not firing, a significant amount of advertising revenue may be lost.

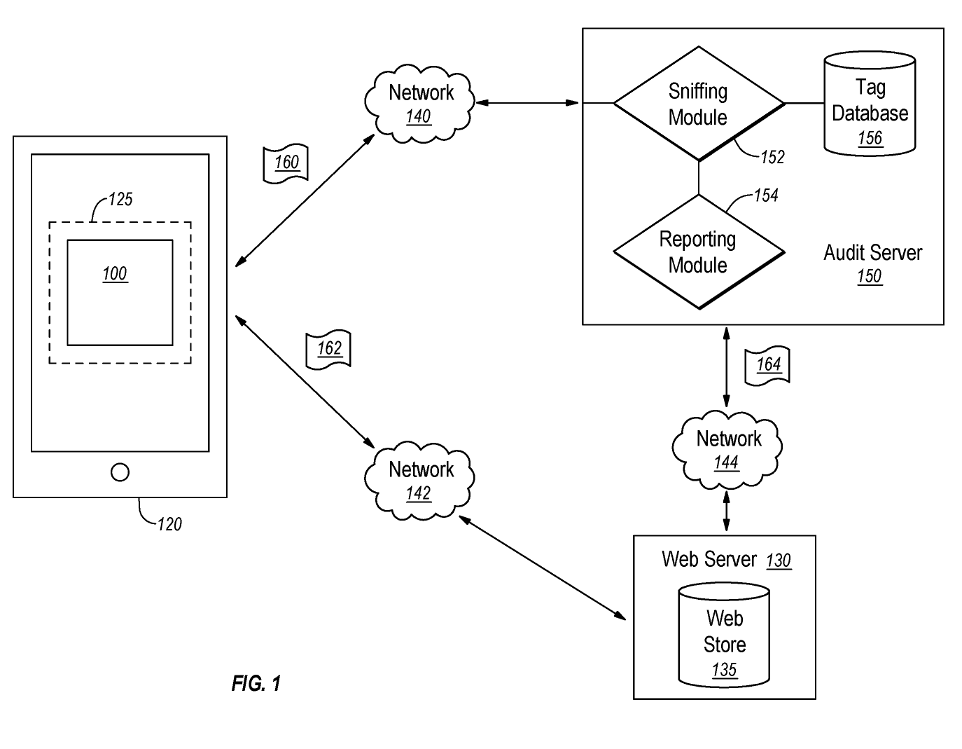

For example, FIG. 1 illustrates an overview schematic diagram of a system for use in accordance with one or more implementations of the present invention. In particular, FIG. 1 depicts a mobile device 120 that comprises at least one mobile application 100. The at least one mobile application 100 may be configured to access web content from a particular content provider. For example, the at least one mobile application 100 may comprise a portal to a particular news site. As such, the mobile application may allow a user to access web content from the news provider. Additionally, the mobile device 100 can also be in communication with various servers 130, 150 through network connections 140, 142.

In at least one implementation, the mobile device 100 may also comprise a mobile auditing application 125 that is also installed on the mobile device 100. The mobile auditing application 125 can be configured to intercept network communications that originate from the at least one mobile application 100 (“target mobile application”). The mobile auditing application 125 can intercept the network communications of the target mobile application 100 through a variety of different techniques. For example, the mobile auditing application 125 can comprise an application layer positioned between the target mobile application 100 and the hardware of the mobile device 120. In this configuration, the mobile auditing application 125 can intercept network communications that originate from the target mobile application 100 as they are generated by the application 100.

Additionally, in at least one implementation, the mobile auditing application 125 can detect an indication of a user input within the target mobile application 100. Additionally, the mobile auditing application 125 can further determine that a tag firing is expected in response to the detected user input. For example, the mobile auditing application 125 may detect an indication of the user executing a video within the target mobile application 100. The executed video may be associated with an expected tag. Accordingly, the mobile auditing application 125 can send a notification to audit server 150 to watch for the expected tag.

In at least one implementation, the mobile auditing application 125 can function independent of an audit server 150. For instance, the mobile auditing application 125 can intercept and analyze the network communications all from within the mobile device 120. As such, the disclosure relating to the audit server 150 provided below can all be applied to functions performed by the mobile auditing application 125 within the mobile device 120.

In an alternative implementation, the mobile auditing application 125 can configure settings on the mobile device 120 so that the mobile device 120 communicates through a proxy server (e.g., audit server 150). In at least one implementation, a mobile auditing application is not necessary, and a user can instead manually adjust the settings of the mobile device 120 to communicate through the proxy server.

In the above cases, a network communication 160 originating from the target mobile application 100 is sent through a network connection 140 to an audit server 150 (i.e., proxy server). The audit server 150 can analyze the network communication 160 for the desired tag attributes. Before or after analyzing the network communication 160, the audit server 150 can forward the network communication 164 through a network connection 144 to the originally addressed Web server 130. The Web server 130 can then serve content from its web store 135 back to the target mobile application 100 either through network connection 144 and the audit server 150 or through a direct network connection 142 (network communication 162) to the mobile communication device 120.

Returning to audit server 150, when the audit server 150 receives a network communication 160 from the target mobile application 100 the sniffing module 150 analyzes the network communication 160 to determine if the network communication 160 comprises an indication of a tag firing. In at least one implementation, the sniffing module 152 identifies tags within the network communication 160 through the use of tag signatures. Tag signatures can comprise various attributes that are associated with groups of tags, types of tags, and specific tags. For example, a particular tag may comprise specific elements within its associated URL. For example, the sniffing module 152 can detect the particular text portions within the URL, or it can detect the server that the URL is directed towards. Either of these pieces of information may assist in identifying a particular tag.

The tag database 156 may comprise a repository of various tag signatures. Relying upon the tag database 156, the sniffing module 152 can analyze network communication 160 and identify a variety of tag signatures. In at least one implementation, a user can upload new tag signatures to the tag database 156. Additionally, a user may be able to select specific tags that the sniffing module 152 should identify.

As the sniffing module 152 analyzes network communication 160, the reporting module 154 can generate reports based upon the detected tags. In at least one implementation, reporting module 154 may also be aware of expected tag firings. Information related to the expected tag firings may be provided by a developer of the target mobile application 100, by an associated advertiser, or by some other related party. Using the information of expected tag firings, reporting module 154 can also report on expected tags that did not fire. Reporting module 154 can provide its report through the mobile auditing application 125, through another application installed on an external system, or through any other of a number of means of receiving a report.

In at least one implementation, the reporting module 154 may provide a summary of the detected tag signatures and/or a detailed accounting of all of the tag information. For example, a summary may comprise the identified tags, the tags that were expected to fire, and a brief overview of information about each tag. In contrast, the detailed accounting may comprise specific URLs that were requested, uncategorized tags, times that the tags fired, information that the tags contained, variables associated with the tags, and other similar information.

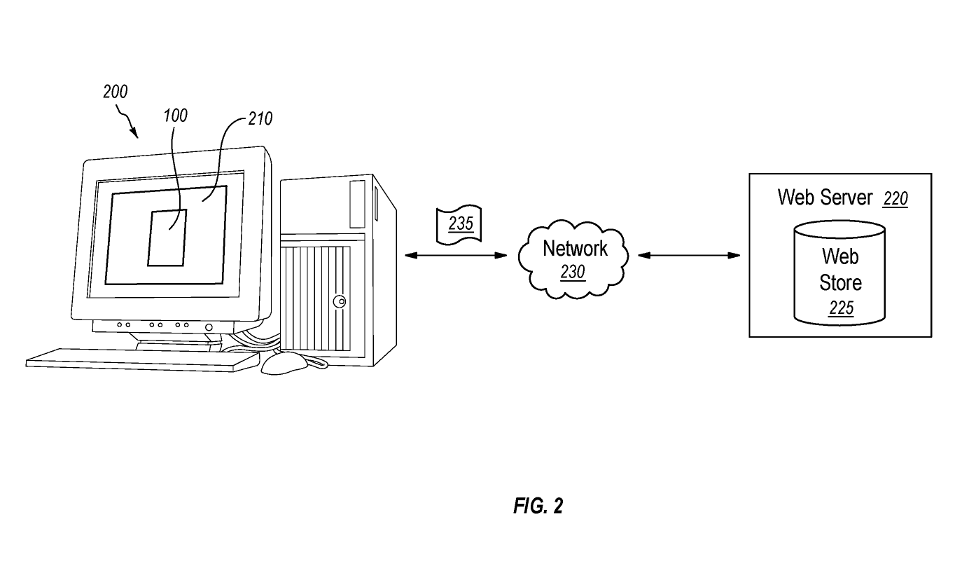

Turning now to FIG. 2, FIG. 2 illustrates an overview schematic diagram of another system for use in accordance with one or more implementations of the present invention. In particular, FIG. 2 depicts a desktop computer that is executing an application interface layer 210. The application interface layer 210 may comprise an emulator or a simulator configured to substantially replicate the function of a mobile device 120. For example, the application interface layer 210 may be able to execute mobile applications 100 that are configured to execute on mobile devices 120. Accordingly, in at least one implementation, a user can execute a target mobile application 100 within the application interface layer 210 on a desktop computer 200. As used herein, a desktop computer 200 can include a laptop computer, a tablet computer, a server, a workstation, a mainframe, or any other computer capable of running an application interface layer 210 as disclosed herein.

In at least one implementation, when a user executes a target mobile application 100 within the application interface layer 210, the application interface layer 210 can intercept network communications 235 that are generated by the target mobile application 100. The intercepted network communications 235 can either be analyzed by the application interface layer 210 or forwarded to an audit server 150 to be analyzed as disclosed above. In either case, the network communications 235 are eventually forwarded on to the intended Web server 220 through network connection 230. As such, either an audit server 150 or an application interface layer 210 can identify tags that are associated with the network traffic of a target mobile application 100.

Allowing a developer to audit a target mobile application 100 within an application interface layer 210 can provide several benefits. For example, an application interface layer 210 allows a developer to test code while it is being written on the desktop computer 200. As such, a developer would not be required to first build and compile a code base, transmit the code base to a mobile device 120, execute the code base on the mobile device 120, review the audit report, and then make the necessary adjustments to the code base. Instead, the application interface layer 210 allows a user to both develop and test the code within the same platform 200.

Additionally, an application interface layer 210 can also be beneficial due to its ability to easily gather input and output generated by the target mobile application 100. Because the application interface layer 200 is aware of the entire target mobile application 100, the application interface layer 210 can identify expected tag firing and detected tag firings in substantially real-time.

For example, the application interface layer 210 can identify that the target mobile application 100 is accessing a particular webpage on a particular website. The application interface layer 210 can access within a database, stored either on the desktop computer 200 or on a remote storage device, the particular tags that are associated within the particular website. The application interface layer 210 can then identify the inputs that are provided to the target mobile application 100, and based upon the identified inputs determine the expected tags. As disclosed above, the application interface layer 210 and/or and audit server 150 can then determine which of the expected tags fired, which tags failed to fire, which tags fired incorrectly, and which tags fired that were not expected.

Similar to the methods disclosed above, the tags can be identified using tag signatures. The identification can occur at the desktop computer 200 or at an external audit server 150. In either case, a report can be generated (e.g., by the auditing server 150) that provides information relating to the tags. The report can comprise a summary of tags detected, tags expected, and type of tags. Additionally, a detailed accounting can provide specific information relating to the tags, when the fired, what information they contained, and other similar information.

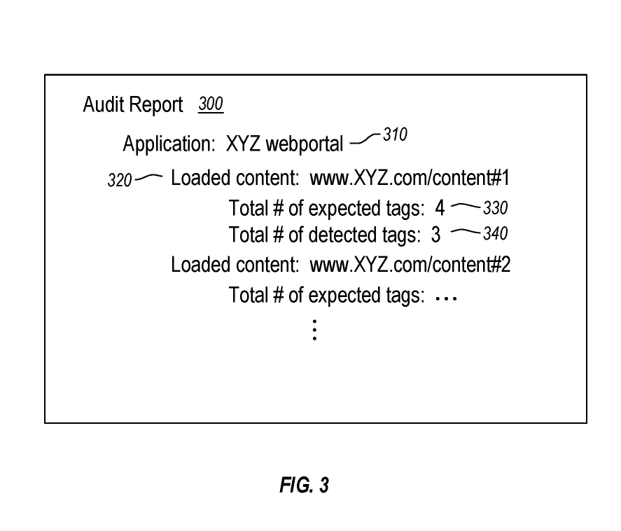

For example, FIG. 3 illustrates an exemplary user interface for reporting an audit in accordance with an implementation of the present invention. In particular, FIG. 3 depicts an audit report 300 that comprises a summary of an audit. The audit report 300 shows an indication of the target application 310. Additionally, the audit report 300 comprises an indication of the web content 320 that was requested by the target mobile application. Associated with each requested web content page 320, the audit report can also comprise an indication of a number of expected tags and the number of actually detected tags.

In at least one implementation, additional information can be available in a detailed account. For example, the detailed accounting can comprise information relating to the specific tags that fired, the URLs that were requested, the timing of the tags, and other similarly related information.

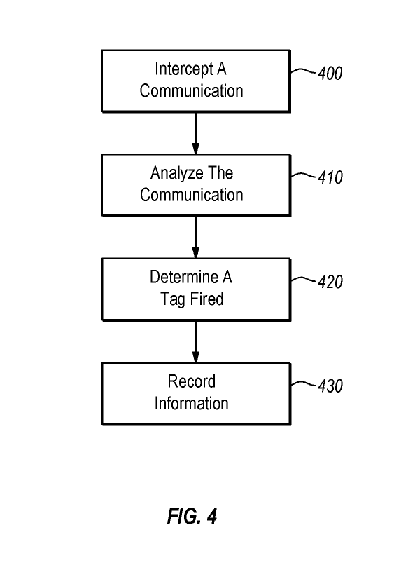

Accordingly, FIGS. 1-3 and the corresponding text illustrate or otherwise describe one or more components, modules, and/or mechanisms for auditing mobile applications. In particular, in at least one implementation, the present invention can audit a mobile application using an external server through which network communications are redirected. Additionally, in at least one implementation of the present invention, the mobile applications can be audited locally either on a mobile device or within an application interface layer on a desktop computer. One will appreciate that implementations of the present invention can also be described in terms of flowcharts comprising one or more acts for accomplishing a particular result. For example, FIGS. 4-6 and the corresponding text describe acts in a method for auditing mobile applications. The acts of FIGS. 4-6 are described below with reference to the elements shown in FIGS. 1-3.

For example, FIG. 4 illustrates that a method for auditing mobile applications can include an act 400 of intercepting a communication. Act 400 can comprise intercepting, with a mobile auditing application, a network communication. The network communication can originate from the target mobile application. Additionally, the mobile auditing application and the target mobile application can both be installed on the mobile device. For example, in FIG. 1, the target mobile application 100 can generate a network communication 160. The network communication 160 can be intercepted by mobile auditing application 125.

FIG. 4 shows that the method can also include act 410 of analyzing the communication. Act 410 can comprise analyzing the network communication to determine if an identifiable tag signature is present within the network communication. An identifiable tag signature can comprise one or more attributes that are associated with the firing of a tag. For example, in FIG. 1, mobile auditing application 125 can analyze network communication 160. In particular, the mobile auditing application 125 either analyze the network communication 160 locally on the mobile device 120 or send the network communication to audit server 150, where the sniffing module 152 can identify various attributes relating to the network communication 160.

Additionally, FIG. 4 shows that the method can include act 420 of determining that a tag fired. Act 420 can comprise, based upon a detected tag signature, determining that a particular tag fired. For example, in FIG. 1, the mobile auditing application 125 can identify various attributes relating to network communication 160. The mobile auditing application 125 can compare these attributes to tag signatures stored in a database accessible to the mobile auditing application 125. Based upon this comparison, mobile auditing application 125 can determine that a particular tag fired.

FIG. 4 also shows that the method can comprise act 430 of recording information. Act 430 includes recording information associated with the particular tag. For example, FIG. 3 depicts a summary report that can be generated by the mobile auditing application 125.

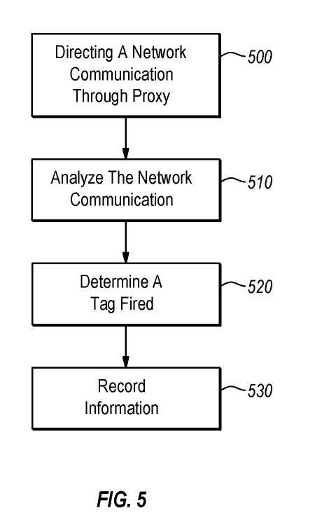

As an additional or alternative implementation, FIG. 5 shows that a method for auditing mobile applications can include act 500 of directing a network communication through a proxy. Act 500 can comprise directing, through a proxy server, a network communication. The network communication can originate from a target mobile application installed on a mobile device or emulator. For example, in FIG. 1, network communication 160 is redirected from webserver 130 such that it first passes through audit server 150. Audit server 150 can analyze network communication 160 with sniffing module 152. In particular, the sniffing module 152 can identify various attributes relating to the network communication 160.

FIG. 5 shows that the method can also include act 510 of analyzing the communication. Act 510 can comprise analyzing the network communication to determine if an identifiable tag signature is present within the network communication. An identifiable tag signature can comprise one or more attributes that are associated with the firing of a tag. For example, in FIG. 1, audit server 150 can analyze network communication 160 with sniffing module 152. In particular, the sniffing module 152 can identify various attributes relating to the network communication 160.

Additionally, FIG. 5 shows that the method can include act 520 of determining a tag fired. Act 520 can comprise, based upon a detected tag signature, determining that a particular tag fired. For example, in FIG. 1, the sniffing module 152 can identify various attributes relating to network communication 160. The sniffing module 152 can compare these attributes to tag signatures stored in the tag database 156. Based upon this comparison, the audit server 150 can determine that a particular tag fired.

FIG. 5 also shows that the method can comprise act 530 of recording information. Act 530 includes recording information associated with the particular tag. For example, FIG. 3 depicts a summary report that the reporting module of FIG. 1 can generate.

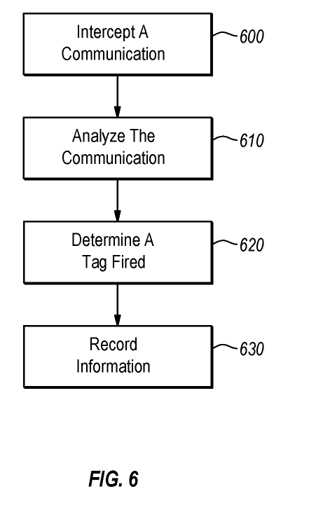

As yet another additional or alternative implementation, FIG. 6 illustrates that a method for auditing mobile applications can include an act 600 of intercepting a communication. Act 600 can comprise intercepting, with an application interface layer, a network communication. The network communication can originate from the target mobile application. Additionally, the application interface layer can be installed on a desktop computer, and the target mobile application can be installed within the application interface layer. For example, in FIG. 2, the target mobile application 100 can generate a network communication 160. The network communication 160 can be intercepted by the application interface layer 210, which is installed on the desktop computer 200. The application interface layer 210 may comprise a simulator, an emulator, or a similar application configured to execute mobile applications.

FIG. 6 shows that the method can also include act 610 of analyzing the communication. Act 610 can comprise analyzing the network communication to determine if an identifiable tag signature is present within the network communication. An identifiable tag signature can comprise one or more attributes that are associated with the firing of a tag. For example, in FIG. 2, application interface layer 210 can analyze network communication 235. In particular, the application interface layer 210 analyzes the network communication 235 locally on the desktop computer 200.

Additionally, FIG. 6 shows that the method can include act 620 of determining a tag fired. Act 620 can comprise, based upon a detected tag signature, determining that a particular tag fired. For example, in FIG. 2, the application interface layer 210 can identify various attributes relating to network communication 160. The application interface layer 210 can then compare these attributes to tag signatures stored in a database accessible to the application interface layer 210. Based upon this comparison, application interface layer 210 can determine that a particular tag fired.

FIG. 6 also shows that the method can comprise act 630 of recording information. Act 630 includes recording information associated with the particular tag. For example, FIG. 3 depicts a summary report that can be generated by the mobile auditing application 125.

Accordingly, one or more implementations of the present invention allow a user to audit tags associated with mobile applications. Additionally, in various implementations, a user is able to audit mobile applications using a variety of different systems and configurations. Implementations of the present invention provide significant improvements within the technical field of tag auditing. For example, implementations of the present invention allow tags fired by a mobile application to be analyzed—something that was not previously possible within the field. Additionally, implementations of the present invention improve the performance of a computer system by allowing for an automated auditing system to ensure that tags are efficiently and correctly firing.

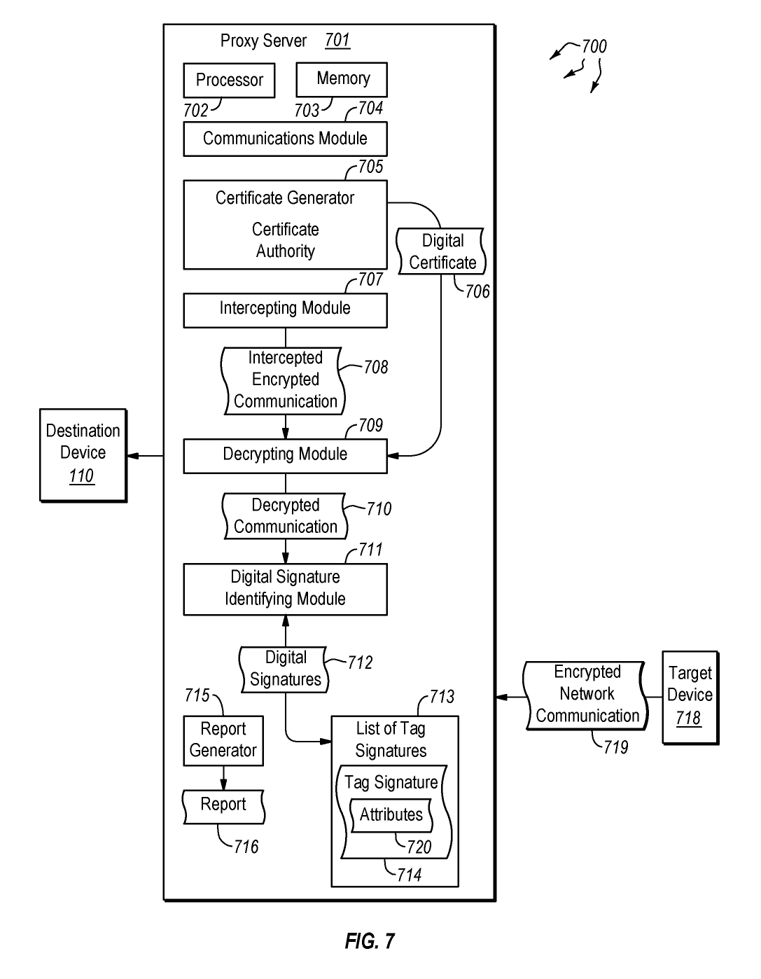

Turning now to FIG. 7, a proxy server 701 is illustrated which is configured to intercept encrypted network communications (e.g. 719) sent form a target device 718 to a destination device 717. Each of the proxy server 701, the target device 718 and the destination device 717 may be computer systems of varying types including local computer systems, distributed computer systems, mobile computer systems, embedded computer systems or other types of computing devices. The proxy server 701, for example, includes at least one hardware processor 702, system memory 703, and a communications module 704 for communicating with other computing systems and/or virtual machines. For example, the proxy server 701 may be use the communications module 704 to receive encrypted network communications 719 from target device 718, and send communications to destination device 717. It will be understood that the proxy server 701 may communicate with substantially any number of other computer systems and/or virtual computer systems.

The proxy server 701 further includes a certificate generator 705 that is configured to generate digital certificates. For example, certificate generator 705 may generate digital certificate 706. The proxy server 701 is a certificate authority for the generated digital certificate 706. As such, the proxy server 701 is permitted to decrypt anything that is encrypted using the digital certificate 706. The intercepting module 707 of the proxy server 701 is configured to intercept encrypted network communications that originate from the target device 718. For instance, the intercepting module 707 may intercept encrypted network communication 719 which is addressed to a destination device other than the proxy server (such as destination device 717).

Once intercepted, the encrypted network communication 719 is fed to the decrypting module 709 of the proxy server 701. The decrypting module 709 may be part of or at least used in an emulator or virtual machine. For example, an emulator or virtual machine may be instantiated and configured to run various programs including programs that generate or implement encrypted network communications. Thus, as part of an emulation, the decrypting module may use the digital certificate 706 to decrypt the intercepted network communication 719. Because the proxy server 701 is a certificate authority for the digital certificate 706, the digital certificate may be used to decrypt the encrypted network communication 719. The proxy server 701 may be a certificate for substantially any number of digital certificates.

The decrypted communication 710 is then sent to a digital signature identifying module 711 of the proxy server 701. The digital signature identifying module 711 is configured to identify digital signatures 712 within the decrypted network communication that match at least one digital signature from a pre-defined list of tag signatures 713. Each tag signature 714 has various attributes that are associated with the firing of a tag. Thus, by identifying digital signatures 712 that match the tag signatures 714, the proxy server 701 can determine which tags actually fired as a result of the encrypted network communication 719. In this manner, the proxy server 701 can continually intercept encrypted network communications (e.g. 719), decrypt them, find out which digital signatures are present in the decrypted communication, and compare the digital signatures to the list of tag signatures 713 to determine which tags fired as a result of the communication 719.

The report generator 715 of the proxy server 701 may generate reports 716 that indicate which digital signatures of the decrypted network communication were found to match the tag signatures 714. The generated report 716 also indicates which tag attributes 720 are associated with the tag signatures 714. The tag attributes may be used to distinguish tags from one another. For instance, the firing of a tag may indicate that a certain button was clicked on or touched within a user interface on the target device 718. The user interface may be part of an application (or “app”), or may be part of a web page displayed on a browser, or may be part of a game or operating system. In response to the user input, the target device may send an encrypted communication (e.g. 719) to a destination device 717). This communication may be intercepted and analyzed by the proxy server 701.

In one example, the encrypted network communication 719 may be sent from the target device 718 to the destination device 717 as a result of a target device user clicking on or touching an advertisement. The advertisement may be displayed in a user interface in an application. Once clicked, the advertisement may trigger the execution of code such as JavaScript or other code to communicate with an outside server such as destination device 717. Upon receiving this communication, the destination device 717 would reply back with further information regarding the advertisement. By intercepting and analyzing these communications, the proxy server 701 can determine which advertisements were triggered, and can determine further characteristics of the advertisement via the tag signature attributes 720.

In some embodiments, the encrypted network communications 719 are generated within the proxy server 701. As mentioned above, the communications module 704 may be configured to communicate with emulators or virtual machines. In some cases, the proxy server 701 may instantiate an emulator that emulates the functionality of another device or computer system such as target device 718. In this manner, the proxy server 701 may instantiate the emulator and cause inputs to be provided to the emulator. These inputs may indicate that the emulator is to instantiate one or more applications such as games, internet browsers, office suites, music applications or other types of applications. The inputs may further include touch or click inputs or even natural language inputs or gestures directed to the application(s). These inputs may cause the applications to perform functionality including displaying advertisements. The inputs may activate the advertisements and thereby trigger the firing of a tag.

Once the advertisement (or other feature) is selected, the emulator will generate and transfer an encrypted network communication 719 directed to a destination device 717. This encrypted network communication 719 can then be intercepted by the intercepting module 707, decrypted by the decrypting module 709, and analyzed for digital signatures 712. Upon finding signature matches to tag signatures 714, the proxy server 701 can determine which tags fired and provide a report thereon. In some cases, the emulator instantiated by the proxy server 701 is configured to simulate execution of an application by a specific mobile device. For instance, the emulator may be configured to simulate execution of an application by a device produced by a specific manufacturer, or may be a certain type of device such as a tablet or smart watch or laptop. As such, the emulator may be able to test a variety of applications on a variety of different emulated platforms. Indeed, the certificate generator 705 may generate certificates for many different types of target devices 718.

In addition to the modules and components described above, the proxy server 701 may also include a receiver that receives user input (such as touch input or mouse input), a determining module that determines an expected tag based upon the user input, and a comparison module that compares a given tag with the expected tag. The determining module may identify which user input was provided at the receiver, and identify which of a plurality of different tags would be expected to fire based on the input. Then, the comparison module of the proxy server 701 may compare the expected tags to the tags that were actually fired based on the input. If there are differences between the expected tag and the actually-fired tag, the proxy server 701 may make a note of the new correlation between input and actually-fired tag. The report generator 715 may generate a report of any resulting information. The report may include a summary of any recorded information including indications of which tags were expected for which inputs, and which tags actually fired for each input.

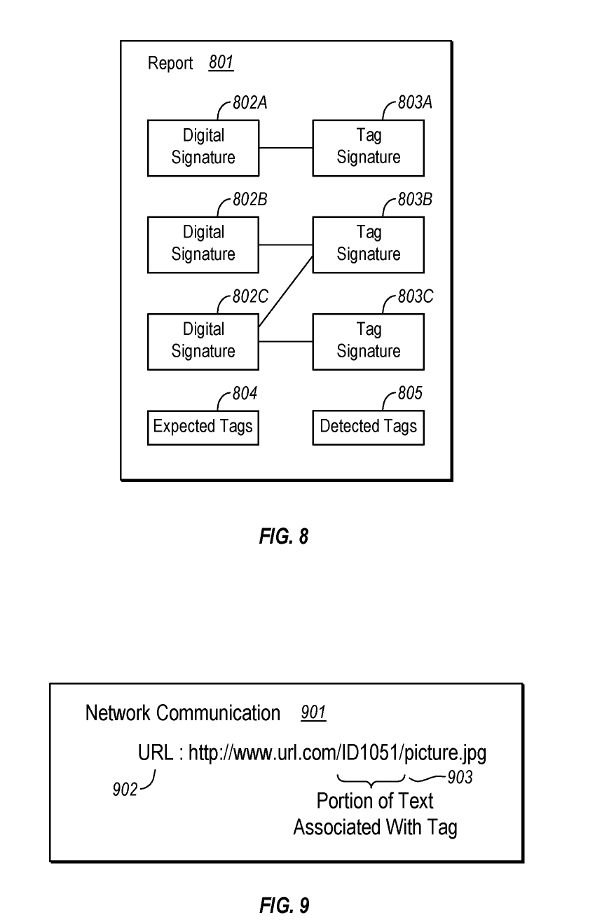

For example, as shown in FIG. 8, a report 801 may include an indication of which digital signatures matched which tag signatures. For instance, digital signature 802A matches tag signature 803A, digital signature 802B matches tag signature 803B, and digital signature 802C matches tag signatures 803B and 803C. As will be understood by one skilled in the art, this report is a very simplified example of the reports that may be generated, and is provided to provide examples of reporting principles. The report 801 may also include an indication of expected tags 804 and detected tags 805. These may be arranged per user input or in some other fashion. Thus, the report may indicate, for each user input, which tags were expected to fire (804), and which tags actually fired (805). This information may be useful in determining the functionality of the applications running on the target device (or emulated target device). Indeed, by providing user inputs, and learning which tags actually fire, the proxy server 701 can learn a great deal about how the applications work.

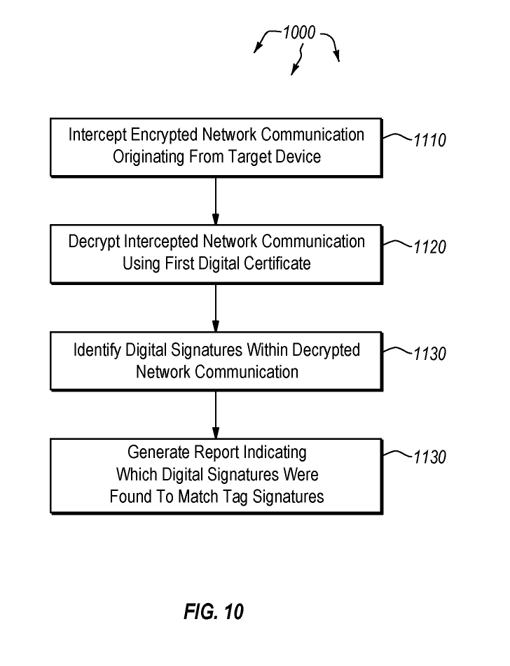

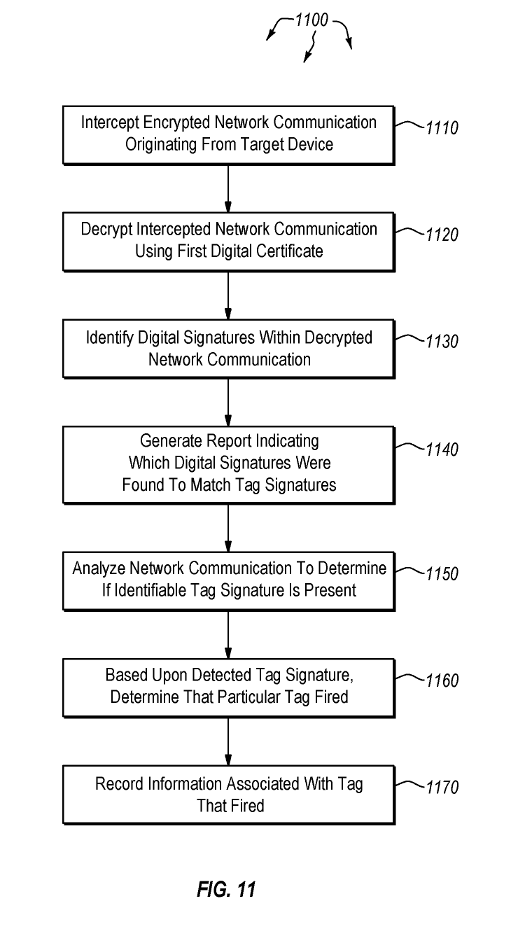

Methods 1000 and 1100 will now be described in conjunction with the computing environment 700 of FIG. 7, the report 801 of FIG. 8, and the example network communication 901 of FIG. 9. In view of the systems and architectures described above, methodologies that may be implemented in accordance with the disclosed subject matter will be better appreciated with reference to the flow charts of FIGS. 10 and 11. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 10 illustrates a flowchart of a method 1000 for inspecting encrypted data traffic and generating reports thereon. In one embodiment, a computerized environment (e.g. 700 of FIG. 7) is provided comprising a target device 718 and a proxy server 701. The proxy server 701 is a certificate authority for one or more digital certificates (e.g. 706). The proxy server inspects encrypted data traffic and generates reports thereon. The method steps include intercepting an encrypted network communication that originates from the target device 718 (1010). For example, intercepting module 707 of proxy server 701 may intercept encrypted network communication 719 as it is transmitted from target device 718 to destination device 717. The encrypted network communication 719 is addressed to a destination other than the proxy server, but is intercepted at the proxy server 701 for analysis.

The decrypting module 709 decrypts the intercepted network communication 708 using a digital certificate 706 for which the proxy server is a certificate authority (1020). The certificate generator 705 of the proxy server 701 may generate any number of digital certificates, and may use the digital certificates to decrypt encrypted network communications such as 719. In some cases, the proxy server may emulate the target device 718 and, as such, the target device's encrypted network communications may be decrypted by the proxy server 701. The decrypting module 709 decrypts the encrypted communication and passes the decrypted communication 710 to the digital signature identifying module 711 where digital signatures are identified (1030).

The digital signature identifying module 711 may determine that the decrypted network communication matches at least one digital signature 712 from a pre-defined list of tag signatures 713. The digital signature and tag signature (e.g. 802A and 803A of FIG. 8) may be determined to match if one or more identifiers in the signatures match each other. Each tag signature includes attributes 720 that are associated with the firing of a tag. Thus, if a given tag signature is present, its associated tag has fired, the attributes of which are contained in the tag signature 714. The report generator 715 of the proxy server 701 then generates a report indicating which digital signatures (e.g. 712) of the decrypted network communication were found to match the tag signatures (1040) (an example of which is shown in report 801 of FIG. 8). The generated report may also indicate which tag attributes are associated with which tag signatures.

In some embodiments, the proxy server 701 may be configured to analyze the encrypted network communication to determine whether an identifiable tag signature 714 is present within the encrypted network communication 719. The identifiable tag signature includes attributes that are associated with the firing of a tag. Thus, if a tag is fired based on a specific occurrence within an application (e.g. the triggering of an advertisement), then that tag signature 714 will be present in the encrypted communication. Accordingly, based upon a detected tag signature 714, the proxy server 701 may determine that a particular tag has fired, and may record information associated with that tag. For instance, if the firing of a tag is the result of a user selecting an advertisement within an application, the proxy server may record the action and the advertisement or other information associated with the tag.

In some cases, for example, the encrypted network communication 719 originating from the target device 718 is a web page data request. The web page data request may be the result of a user clicking on, touching or otherwise selecting an advertisement. For instance, within an application running on the target device, a user may interact with content on a web page and ultimately select an advertisement. The selection of the advertisement may result in the firing of a tag. The tag's associated tag signature is transmitted as part of the encrypted network communication 719. Reports generated by the report generator 715 may illustrate which digital signatures of the decrypted network communication were found to match the tag signatures

As mentioned above, reports generated by the report generator 715 may include a representation of expected tags and detected tags. For example, report 716 may include an indication of which tags were expected to fire when a given input was provided at the target device (or at the emulator), and which tags actually fired. Over time, the proxy server 701 may learn which inputs result in which tags firing. In this manner, even if the content of the website or application is not fully known, the proxy server 701 will know which inputs result in which expected outputs.

In some embodiments, identifying digital signatures within the decrypted network communication 719 may include analyzing a uniform resource locator (URL) associated with the network communication, and determining that the URL includes a portion of text that is associated with a particular tag. For example, as shown in network communication 901 of FIG. 9, a URL 902 may include the following text: “http://www.url.com/ID1051/picture.jpg”. The “ID1051” portion of text 903 may be associated with a particular tag. For instance, if a user activates an advertisement, a picture (such as “picture.jpg”) from the ID1051 directory is to be retrieved for the advertisement. The ID1051 portion of text 903 may thus have a tag associated with it that will be fired when a file from that directory is called.

Additionally or alternatively, the “picture.jpg” may be the portion of text 903 that is associated with a tag, and any time that picture is retrieved, the tag is fired. It will be understood that substantially any portion of a URL may have text that is associated with a tag. It will also be understood that any type of uniform resource identifier (URI) or other identifier may be associated with a tag. Accordingly, the proxy server 701 may learn which UI elements or directories or other objects are associated with a given tag. This information may be stored as an attribute 720 in a tag signature 714.

The proxy server 701 may be configured to intercept all encrypted network communications 719, or may be configured to only intercept selected encrypted network communications from the target device 718. For instance, the proxy server 701 may monitor communications from the target device 718 and may determine, over time, which communications are likely to include tags, and which communications are not. As such, the proxy server 701 may learn which communications to intercept and which to allow through without analysis or modification.

When the proxy server 701 is identifying digital signatures within the decrypted network communications 710, the identification may include analyzing the destination of the network communication, and determining that the destination is associated with a particular tag. For instance, if the network communication has a URL (e.g. 902 of FIG. 9) to which it is being sent, the digital signatures identifying module 711 may determine at least some part of the destination (e.g. “www.url.com” or directory “ID 1051”, etc.) is associated with a given tag. Then, when that destination is identified, the tag may be indicated as being fired.

Turning now to FIG. 11, method 1100 will now be described in conjunction with the computing environment 700 of FIG. 7. The method 1100 may be implemented in a computerized environment that includes an auditing system and a mobile application in communication with a network. The method 1100 involves an auditing system such as proxy server 701 auditing tags launched within a mobile application running on a target device 718. The method steps include intercepting an encrypted network communication 719 that originates from the target device 718, where the encrypted network communication is addressed to a destination 717 other than the proxy server (1110).

Next, method 1100 includes decrypting the intercepted network communication using a digital certificate 706 for which the proxy server is a certificate authority (1120), and identifying one or more digital signatures 712 within the decrypted network communication 710 that match at least one digital signature from a pre-defined list of tag signatures 713, where each tag signature includes one or more attributes 720 that are associated with the firing of a tag (1130). The report generator 715 generates a report 716 indicating which digital signatures 712 of the decrypted network communication 710 were found to match the tag signatures, where the generated report further indicates which tag attributes are associated with the tag signatures (1140).

Method 1100 further includes analyzing the decrypted network communication to determine if an identifiable tag signature 714 is present within the decrypted network communication, where an identifiable tag signature includes one or more attributes 720 that are associated with the firing of a tag (1150). Then, based upon a detected tag signature 714, the proxy server 701 determines that a particular tag fired (1160), and records information associated with the particular tag (1170). The information may be recorded in a report (e.g. 801 of FIG. 8), or may be stored in a separate location.

In some cases, a mobile auditing application may be installed on the target device 718. The mobile auditing application may be instantiated on the target device 718 and, once running, may automatically configure the target device such that a target mobile application communicates with the proxy server 701. Thus, the mobile auditing application may forward or reroute traffic generated by the target mobile application to the proxy server 701. In such cases, the proxy server 701 may simply receive the forwarded data packets without needing to intercept the data feed.

Once the traffic arrives at the proxy server 701, the data packets are decrypted using digital certificates. The decrypted communications 710 are searched for digital signatures 712 to determine whether the digital signatures match any tag signatures 714 in a list of tag signatures 713. This searching for digital signatures may include analyzing a URL (e.g. 901) associated with the network communication, and determining that the URL includes a portion of text 903 that is associated with a particular tag. If so, that tag is said to have fired, and a record can be generated. In other cases, determining if an identifiable tag signature 714 is present within the network communication 719 includes analyzing the destination (e.g. a particular server or virtual machine) of the network communication. Those communications going to a particular destination may then be associated with a particular tag and may be associated with the firing of that tag.

Method 1100 may further include optional steps of receiving an indication of a user input, determining an expected tag based upon the user input, and comparing the particular tag with the expected tag. If the comparison of the tag with the expected tag shows a match, then the user input can be said to cause the firing of the expected tag. On the flipside, however, if the comparison of the tag with the expected tag does not result in a match, then the user input can be said not to be associated with the expected tag. Reports generated by the proxy server 701 may include a summary that shows expected tags and detected tags, and may show a visual representation of which detected tags matched the expected tags, and which did not. Thus, in this manner, an auditing system such as proxy server 701 may audit tags launched within a mobile application running on the target device 718.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computerized environment comprising a target device and a proxy server, the proxy server being a certificate authority for one or more digital certificates, a method of inspecting encrypted data traffic and generating reports thereon, the method comprising the proxy server performing the following:
intercepting an encrypted network communication that originates from the target device, wherein the encrypted network communication is addressed to a destination other than the proxy server;
decrypting the intercepted network communication using a digital certificate for which the proxy server is a certificate authority;
identifying one or more digital signatures within the decrypted network communication that match at least one digital signature from a pre-defined list of tag signatures, each tag signature comprising one or more attributes that are associated with the firing of a tag; and
generating a report indicating which digital signatures of the decrypted network communication were found to match the tag signatures, the generated report further indicating which tag attributes are associated with the tag signatures.

2. The method of claim 1, further comprising:
analyzing the decrypted network communication to determine if an identifiable tag signature is present within the decrypted network communication, wherein an identifiable tag signature comprises one or more attributes that are associated with the firing of a tag;
based upon a detected tag signature, determining that a particular tag fired; and
recording information associated with the particular tag.

3. The method of claim 1, wherein the encrypted network communication originating from the target device comprises a web page data request.

4. The method of claim 1, further comprising displaying the generated report indicating which digital signatures of the decrypted network communication were found to match the tag signatures.

5. The method of claim 1, wherein the generated report includes a representation of expected tags and detected tags.

6. The method of claim 1, wherein identifying digital signatures within the decrypted network communication comprises:
analyzing a URL associated with the network communication; and
determining that the URL comprises a portion of text that is associated with a particular tag.

7. The method of claim 1, wherein identifying digital signatures within the decrypted network communication comprises:
analyzing the destination of the network communication; and
determining that the destination is associated with a particular tag.

8. The method of claim 1, wherein the proxy server is the certificate authority for a plurality of digital certificates, allowing the proxy server to decrypt network communications associated with the plurality of digital certificates.

9. The method of claim 1, wherein only selected encrypted network communications from the target device are intercepted by the proxy server.

10. In a computerized environment comprising an auditing system and a mobile application in communication with a network, a method of the auditing system auditing tags launched within the mobile application, the method comprising the acts of:
intercepting an encrypted network communication that originates from the target device, wherein the encrypted network communication is addressed to a destination other than the proxy server;
decrypting the intercepted network communication using a digital certificate for which the proxy server is a certificate authority;
identifying one or more digital signatures within the decrypted network communication that match at least one digital signature from a pre-defined list of tag signatures, each tag signature comprising one or more attributes that are associated with the firing of a tag;
generating a report indicating which digital signatures of the decrypted network communication were found to match the tag signatures, the generated report further indicating which tag attributes are associated with the tag signatures;
analyzing the decrypted network communication to determine if an identifiable tag signature is present within the decrypted network communication, wherein an identifiable tag signature comprises one or more attributes that are associated with the firing of a tag;
based upon a detected tag signature, determining that a particular tag recording information associated with the particular tag.

11. The method as recited in claim 10, wherein a mobile auditing application, which is installed on the target device, automatically configures the target device such that a target mobile application communicates with the proxy server.

12. The method as recited in claim 11, further comprising:
receiving an indication of a user input;
determining an expected tag based upon the user input; and
comparing the particular tag with the expected tag.

13. The method as recited in claim 12 wherein further comprising displaying a summary that shows one or more expected tags and detected tags.

14. The system of claim 10, wherein identifying digital signatures within the decrypted network communication comprises:
analyzing a URL associated with the network communication; and
determining that the URL comprises a portion of text that is associated with a particular tag.

15. The system of claim 10, wherein determining if an identifiable tag signature is present within the network communication comprises:
analyzing the destination of the network communication; and
determining that the destination is associated with a particular tag.

16. A proxy server comprising:
one or more processors;
a communications module for communicating with other computing systems and virtual machines;
a certificate generator configured to generate at least a digital certificate, the proxy server being a certificate authority for the generated digital certificate;
an intercepting module configured to intercept encrypted network communications that originate from a target device, wherein the encrypted network communication is addressed to a destination other than the proxy server;
a decrypting module configured to decrypt the intercepted network communication using the digital certificate for which the proxy server is a certificate authority;
a digital signature identifying module configured to identify one or more digital signatures within the decrypted network communication that match at least one digital signature from a pre-defined list of tag signatures, each tag signature comprising one or more attributes that are associated with the firing of a tag; and
a report generator configured to generate a report indicating which digital signatures of the decrypted network communication were found to match the tag signatures, the generated report further indicating which tag attributes are associated with the tag signatures.

17. The computer system of claim 16, further comprising a mobile device simulator configured to simulate execution of an application by a mobile device.

18. The computer system of claim 16, wherein the certificate generator generates certificates for a plurality of target devices.

19. The computer system of claim 16, further comprising:
a receiver for receiving user input;
a determining module configured to determine an expected tag based upon the user input; and
a comparison module for comparing the particular tag with the expected tag.

20. The method as recited in claim 19, further comprising displaying a summary of the recorded information, wherein the summary of the recorded information comprises an indication of the expected tag and the particular tag.
